(19) United States
(12) Patent Application Publication
(10) Pub. No.: US 2018/0283343 A1
(43) Pub. Date: Oct. 4, 2018

(54) Method for Starting an Internal Combustion Engine

(71) Applicant: Bayerische Motoren Werke Aktiengesellschaft, Muenchen (DE)

(72) Inventor: Din WABBALS, Muenchen (DE)

(21) Appl. No.: 16/002,161

(22) Filed: Jun. 7, 2018

Related U.S. Application Data
(63) Continuation of application No. PCT/EP2016/080248, filed on Dec. 8, 2016.

(30) Foreign Application Priority Data
Dec. 10, 2015 (DE) 10 2015 224 758.9

(51) Int. Cl. F02N 19/00; F01L 1/34; F01L 13/08; F02D 13/02; F02D 41/06; F02D 41/04; F02N 11/08

(52) U.S. Cl. CPC F02N 19/004; F01L 1/34; F01L 13/08; F02D 13/0226; F02D 41/062; F02D 41/042; B60W 30/192; F02N 11/0814; F01L 2800/01; F01L 2800/03; F02N 2200/023; F02N 2019/008; F02N 19/005

(57) ABSTRACT

A method for starting or stopping an internal combustion engine which reduces starter loading and engine vibrations is provided. The method includes varying a valve stroke of at least one cylinder of the engine such that during the starting or stopping procedure the at least one cylinder undergoes decompression.

### CROSS REFERENCE TO RELATED APPLICATIONS

This application is a continuation of PCT International Application No. PCT/EP2016/080248, filed Dec. 8, 2016, which claims priority under 35 U.S.C. § 119 from German Patent Application No. 10 2015 224 758.9, filed Dec. 10, 2015, the entire disclosures of which are herein expressly incorporated by reference.

### BACKGROUND AND SUMMARY OF THE INVENTION

The present invention relates to a method for starting an internal combustion engine. The invention further relates to a computer program product and to a control device for carrying out said method.

It is known from the prior art to start internal combustion engines with a starter. Here, depending on their respective cycle, the cylinders of the internal combustion engine have to suck in and compress fresh air or a fresh air/combustion agent mixture. However, such complete suction and compression is not necessary to start up the internal combustion engine and leads rather to considerable loading of a starter mechanism and to a start-up which is conspicuous in terms of acoustics and vibrations.

It is an object of the present invention to provide a method for starting an internal combustion engine which allows secure, reliable and low-vibration start-up of an internal combustion engine while being simple and cost-effective.

The object is achieved by a method for starting an internal combustion engine, wherein at least one cylinder of the internal combustion engine is decompressed during the starting operation. In particular, the cylinder is decompressed with the intake valve closed. The term “decompressed cylinder” is to be understood as meaning that the cylinder, in particular after an induction cycle, has a smaller air volume than could be filled at most into the cylinder under the conditions outside the internal combustion engine. Thus, a negative pressure in relation to the surroundings of the internal combustion engine prevails in the decompressed cylinder. In particular, the negative pressure prevails after an induction cycle of the cylinder of the internal combustion engine. The decompression of the cylinder is achieved in that a valve stroke of the intake valve is varied. In particular, the valve stroke is minimized. Here, the term “valve stroke” is understood to mean that travel which the intake valve covers during a complete opening movement. Thus, the valve stroke corresponds in particular to the distance between a position in which the intake valve is completely opened and a position in which the intake valve is completely closed. In order to set the valve stroke, the internal combustion engine advantageously has a variable valve control mechanism. The valve stroke is set in particular in such a way that a reduced air quantity can enter the cylinder, with the result that the cylinder is not completely filled with air. Thus, after closing the valve, a negative pressure is generated within the cylinder, with the result that the cylinder is decompressed. The decompression of the cylinder means that, during start-up of the internal combustion engine, the cylinder has to perform a reduced amount of compression work, with the result that, on the one hand, the mechanism of a starting device of the internal combustion engine is protected and at the same time a vibrational behavior of the internal combustion engine is optimized.

The method described can also be applied to a stopping operation of the internal combustion engine. Here, the same decompression as described above is advantageous, with the internal combustion engine not being driven by an external starter device but, rather, the internal combustion engine running to a stop until stationary. A vibrational behavior of the internal combustion engine is improved due to the decompression of the at least one cylinder by virtue of varying the valve stroke of the intake valve.

In a preferred embodiment of the invention, the intake valve is closed before a piston assigned to the cylinder reaches a bottom dead center. In particular, the bottom dead center represents an end of an induction cycle of the piston. Such an advanced closure, that is to say a closure before the piston reaches the bottom dead center, causes a negative pressure to be generated within the cylinder, with the result that the piston has to perform a reduced amount of compression work during a subsequent compression cycle.

There is advantageously provision that a decompression level is individually set for each cylinder of the internal combustion engine. Thus, in particular, the air quantity which is present within its cylinder is individually set. In this way, the starting operation of the internal combustion engine, that is to say a transition from a rotation of the internal combustion engine by a starting device to a rotation of the engine by the operations of pistons of the internal combustion engine, can be optimized. At the same time, it is ensured that the starting operation proceeds with very little vibration and in an acoustically quiet manner, with the result that a user of the internal combustion engine is not disturbed by the starting operation.

A valve stroke particularly advantageously comprises a stroke between zero millimeter and two millimeters, in particular between zero millimeter and one millimeter. Such values ensure that only a minimum air quantity, if any, can enter the cylinder, with the result that the cylinder is decompressed and has to perform only a small amount of compression work. If no fresh air enters the cylinder, which is achieved with a valve stroke of zero millimeter, combustion within the cylinder is possible in particular due to fresh air already present in the cylinder.

In addition, the decompression is preferably obtained by adjusting a camshaft of the internal combustion engine in the direction of advanced intake spreads. For this purpose, the internal combustion engine advantageously has a variable camshaft adjustment system, which is realized in particular by phase adjusters. Adjusting the camshaft in the direction of advanced intake spreads results in the intake valve closing very early. Thus, there is provision in particular that the intake valve is closed before a piston of the cylinder reaches a bottom dead center. In this way, a negative pressure is generated within the cylinder. Thus, the piston of the cylinder has to perform only a small amount of compression work.

In addition, the decompression is preferably obtained in that at least one zero stroke occurs. In the case of the zero stroke, the inlet valve of the cylinder remains closed. Thus, no fresh air can be sucked into the cylinder, with the result that a reduced amount of compression work can be performed within the cylinder. In this way, the above-described advantages are achieved. Combustion within the cylinder is preferably made possible by fresh air already present in the cylinder.

It is particularly advantageous for the crankshaft of the internal combustion engine when stationary to have a predefined position. There is provision here that the filling level of the at least one cylinder is set by the predefined position. Thus, a level of the decompression of the cylinder is predetermined by the position of the crankshaft. There is particular provision here that the internal combustion engine is shut off in a targeted manner, that is to say that, when shutting off the internal combustion engine, the crankshaft assumes the predefined position. Thus, in particular, the filling volume of all the cylinders is predetermined by the position of the crankshaft. In addition, the cylinders are not filled with new air, with the result that the filling volume of the cylinders that is set by the crankshaft is maintained. In particular, the predefined position of the crankshaft is selected in such a way that the cylinder, in particular each cylinder of the internal combustion engine, is not situated at its bottom dead center. It is thus ensured that a filling volume of the cylinder is smaller than a maximum filling volume. In this way, the cylinder is decompressed.

The orientation of the crankshaft such that it is stationary in the predefined position is achieved in particular by a starter device. The crankshaft is able to be rotated by the starter device. The predefined position can thus be set. As an alternative to the starter device, the predefined position of the crankshaft can also be set by an alternative drive, such as, in particular, an electric machine. For this purpose, there is provision that the crankshaft of the internal combustion engine is able to be rotated by the alternative drive.

There is particularly advantageously provision that all the cylinders of the internal combustion engine are decompressed in order to start the internal combustion engine. Thus, a low-noise and low-vibration start-up of the internal combustion engine can be achieved, with at the same time a starter mechanism of the internal combustion engine being relieved.

In addition, the decompression is advantageous if the internal combustion engine is in overrun operation. An overrun operation occurs in particular when an alternative drive is present. If the internal combustion engine is part of a vehicle, the alternative drive is in particular an electric motor. If the vehicle is driven by the electric motor without disconnecting the internal combustion engine, the internal combustion engine is in overrun operation. Here, there is preferably provision to decompress at least one cylinder by varying the valve stroke of the intake valve in order to minimize resistance of the internal combustion engine in overrun operation and to improve vibrational comfort. The internal combustion engine is preferably started again by the alternative drive after completion of the overrun operation.

Furthermore, there is preferably provision to vary, at least during the starting operation, a valve stroke of the intake valve on the basis of surrounding conditions, in particular on the basis of a surrounding temperature, and/or on the basis of an operating temperature of the internal combustion engine. It is thus possible to create advantageous boundary conditions for the start-up of the internal combustion engine in dependence on current surrounding conditions. In particular, the level of the decompression is variable as a result, which means that an advantageous air quantity is always present within the cylinder.

The invention further relates to a computer program product. The computer program product comprises a machine-readable code for carrying out the method as described above. For this purpose, there is provision in particular that the computer program product is executed on a computer device. The computer device is advantageously a control device, in particular a microchip.

The invention further relates to a control device for an internal combustion engine. The control device is advantageously designed to start the internal combustion engine according to a method as described above. Thus, the control device allows a low-vibration and low-noise engine start-up in which the starter mechanism is relieved.

There is particularly advantageously provision that the internal combustion engine is a drive of a motor vehicle, in particular of a passenger car. Here, the method for starting the internal combustion engine can be carried out on the one hand if a driver of the vehicle initiates a key start, that is to say intends to manually start the engine. On the other hand, the method can be carried out if the internal combustion engine is intended to be automatically started again after an automated stop, for example when a vehicle is waiting at traffic lights.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 shows a schematic illustration of an internal combustion engine which can be started by a method according to an embodiment of the invention.

### DETAILED DESCRIPTION OF THE DRAWING

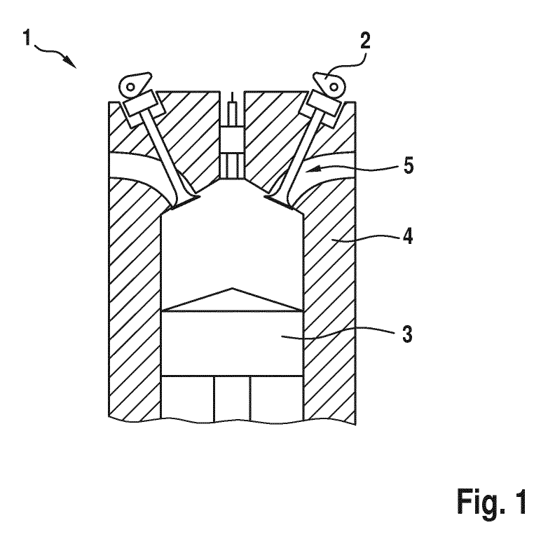

FIG. 1 shows an internal combustion engine 1. The internal combustion engine 1 comprises a cylinder 4 in which a piston 3 can be moved. An intake valve 5 of the internal combustion engine 1 can be activated via a camshaft 2.

There is provision that all the cylinders 4 of the internal combustion engine 1 are decompressed if the internal combustion engine 1 is started. The decompression, in particular a level of the decompression, can be set to different degrees for this purpose. Thus, there is provision in particular that the inlet valve 5 is activated by a variable valve control mechanism in such a way that a valve stroke is set between 0 mm and 2 mm, preferably between 0 mm and 1 mm. Alternatively or in addition, there is provision that the camshaft 2 is adjusted in the direction of advanced intake spreads by a camshaft adjustment system, in particular by phase adjusters. In this way, the intake valve 5 closes before the piston 3 reaches a bottom dead center.

The decompression of the cylinder 4 ensures that the piston 3 has to perform only a small amount of compression work if it is moved from the bottom dead center to the top dead center in the compression cycle. In this way, a vibrational behavior and a noise emission of the internal combustion engine 1 during the starting operation is optimized, with at the same time a starter mechanism of the internal combustion engine 1 being relieved.

Furthermore, it is advantageous for a decompression to be present by setting a zero stroke of the intake valve 5. For this purpose, there is advantageously provision that the internal combustion engine 1 is shut off in a targeted manner. A crankshaft (not shown) of the internal combustion engine 1 has a predefined position due to a targeted shut-off. In the predefined position, a filling level of each cylinder 4 of the internal combustion engine 1 is predefined. Thus, it is possible by selecting the predefined position to determine which cylinder 4 is intended to have which filling level. If a filling level is selected in which the piston 3 is not situated at its bottom dead center, the filling level of the cylinder 4 is smaller than a maximum filling level. The maximum filling level corresponds to that volume which the cylinder 4 has if the piston 3 has arrived at the bottom dead center. A decompression of the cylinder 4 is present due to the smaller filling level. Thus, the piston 3 has to perform only a small amount of compression work if it is moved in the compression cycle from the bottom dead center to the top dead center.

At the end of the starting operation there is advantageously provision that the valve stroke of the intake valve 5 is increased in order to change to a conventional operation of the internal combustion engine 1. In addition, during the starting operation there is preferably provision that a valve stroke of the intake valve 5 and an adjustment of the camshaft 2 is undertaken on the basis of surrounding conditions, in particular on the basis of a surrounding temperature, and/or on the basis of an operating temperature of the internal combustion engine 1.

The above-described possibility of decompressing the cylinder 4 is advantageous not only in the case of a starting operation of the internal combustion engine 1. The decompression as described above can also occur if the internal combustion engine 1 is intended to be stopped. If the internal combustion engine 1 is used in a vehicle as a drive, it may be required, in particular in the case of hybrid vehicles, that an alternative drive is intended to move the vehicle. If it is intended in this case for the internal combustion engine 1 to be further rotated, a decompression of the cylinder 4, preferably of all the cylinders 4 of the internal combustion engine 1, is advantageously provided in order thereby to relieve the alternative drive.

If the internal combustion engine is started with the described decompressed cylinders 4, there results an advantage in respect of vibrational comfort and acoustics and a reduction in a power requirement to the starter system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Internal combustion engine
2 Camshaft
3 Piston
4 Cylinder
5 Intake valve

What is claimed is:

1. A method for starting or stopping an internal combustion engine, comprising the acts of:
initiating a starting operation or a stopping operation,
varying a valve stroke of an intake valve of at least one cylinder of the internal combustion engine such that the at least one cylinder is placed in a decompression state in which a reduced pressure is achieved relative to a pressure that would be present in the at least one cylinder when the valve stroke of the intake valve is a full valve stroke.

2. The method as claimed in claim 1, wherein
the intake valve is closed before a piston assigned to the at least one cylinder reaches a bottom dead center.

3. The method as claimed in claim 1, wherein
a decompression level is individually set for each of the at least one cylinders of the internal combustion engine.

4. The method as claimed in claim 1, wherein
the valve stroke is between 0 mm and 2 mm.

5. The method as claimed in claim 1, wherein
the valve stroke is between 0 mm and 1 mm.

6. The method as claimed in claim 1, wherein
the varying of the valve stroke to obtain the decompression state is performed by setting a camshaft of the internal combustion engine in the direction of advanced intake spreads.

7. The method as claimed in claim 1, wherein
the decompression state is obtained by setting the valve stroke to be a zero stroke in which the intake valve remains closed.

8. The method as claimed in claim 7, wherein
a filling level of the at least one cylinder is set by positioning a crankshaft of the internal combustion engine in a predefined stationary position.

9. The method as claimed in claim 8, wherein
the predefined stationary position of the crankshaft is set by at least one of a starter and an electric machine.

10. The method as claimed in claim, wherein
all of the at least one cylinder are decompressed when the internal combustion engine is started.

11. The method as claimed in claim, wherein
the varying the valve stroke of the inlet valve to obtain the decompression state of the at least one cylinder of the internal combustion engine is performed is obtained by varying the valve stroke of the inlet valve during an overrun operation.

12. The method as claimed in claim 1, wherein
the varying of the valve stroke is based on at least one of a surrounding temperature and an operating temperature of the internal combustion engine.

13. A computer program product comprising:
machine-readable code contained on a tangible medium, the machine-readable code being configured to be executable on a computer device to
initiate a starting operation or a stopping operation,
vary a valve stroke of an intake valve of at least one cylinder of the internal combustion engine such that the at least one cylinder is placed in a decompression state in which a reduced pressure is achieved relative to a pressure that would be present in the at least one cylinder when the valve stroke of the intake valve is a full valve stroke.

14. A control device for an internal combustion engine, comprising:
a computer configured to
initiate a starting operation or a stopping operation,
vary a valve stroke of an intake valve of at least one cylinder of the internal combustion engine such that the at least one cylinder is placed in a decompression state in which a reduced pressure is achieved relative to a pressure that would be present in the at least one cylinder when the valve stroke of the intake valve is a full valve stroke.
